(19) United States
(12) Patent Application Publication
(10) Pub. No.: US 2025/0342679 A1
(43) Pub. Date: Nov. 6, 2025

(54) POSE ANALYZING APPARATUS, POSE ANALYZING METHOD, AND NON-TRANSITORY COMPUTER-READABLE STORAGE MEDIUM

(71) Applicant: NEC Corporation, Minato-ku, Tokyo (JP)

(72) Inventors: Karen STEPHEN, Tokyo (JP); Jianquan LIU, Tokyo (JP); Noboru YOSHIDA, Tokyo (JP); Ryo KAWAI, Tokyo (JP); Tingting DONG, Tokyo (JP); Yuta NAMIKI, Tokyo (JP); Satoshi YAMAZAKI, Tokyo (JP); Naoki SHINDOU, Tokyo (JP); Youhei SASAKI, Tokyo (JP)

(73) Assignee: NEC Corporation, Minato-ku, Tokyo (JP)

(21) Appl. No.: 18/865,816

(22) PCT Filed: Jun. 3, 2022
(86) PCT No.: PCT/JP2022/022603

§ 371 Date: Nov. 14, 2024

(51) Int. Cl. G06V 10/762; G06T 7/73; G06V 10/74; G06V 10/764; G06V 40/10

(52) U.S. Cl. CPC G06V 10/762; G06T 7/74; G06V 10/761; G06V 10/764; G06V 40/10; G06T 2207/30196

(57) ABSTRACT

A pose analyzing apparatus acquires a target image and estimates a pose for each person. The target image includes two or more persons captured by a camera. The person does arbitrary thing, such as giving a performance, doing exercises, playing music instruments, etc. The pose analyzing apparatus classifies the persons into two or more pose groups based on the poses of the persons, and outputs group information that includes information about at least one of the pose groups.

### TECHNICAL FIELD

The present disclosure generally relates to a pose analyzing apparatus, a pose analyzing method, and a non-transitory computer-readable storage medium.

### BACKGROUND ART

There are techniques to analyze an image of a person. PTL1 discloses a system that analyzes an image of a class student to determine a current class status, such as a degree of concentration. The class status is determined by comparing the characteristics, e.g., pose, of the class student captured on the image with those obtained from a pre-stored class status sample image.

### CITATION LIST

### Patent Literature

PTL1: US Patent Publication No. US2020/0126444

### SUMMARY OF INVENTION

### Technical Problem

PTL1 does not disclose a technique to handle an image on which two or more persons are captured. An objective of the present disclosure is to provide a novel technique to analyze poses of persons using an image on which two or more persons are captured.

### Solution to Problem

The present disclosure provides a pose analyzing apparatus comprising at least one memory that is configured to store instructions and at least one processor.

The at least one processor is configured to execute the instructions to: acquire a target image on which two or more persons are captured; estimate a pose for each one of the persons; classify the persons into two or more pose groups based on the poses of the persons; and output group information that includes information about at least one of the pose groups.

The present disclosure further provides a pose analyzing method performed by a computer.

The pose analyzing method comprises: acquiring a target image on which two or more persons are captured; estimating a pose for each one of the persons; classifying the persons into two or more pose groups based on the poses of the persons; and outputting group information that includes information about at least one of the pose groups.

The present disclosure further provides a non-transitory computer readable storage medium storing a program.

The program causes a compute to execute: acquiring a target image on which two or more persons are captured; estimating a pose for each one of the persons; classifying the persons into two or more pose groups based on the poses of the persons; and outputting group information that includes information about at least one of the pose groups.

### Advantageous Effects of Invention

According to the present disclosure, a novel technique to analyze poses of persons using an image on which two or more persons are captured is provided.

### BRIEF DESCRIPTION OF DRAWINGS

FIG. 1 illustrates an overview of a pose analyzing apparatus.

FIG. 2 is a block diagram illustrating an example of a functional configuration of the pose analyzing apparatus.

FIG. 3 is a block diagram illustrating an example of a hardware configuration of the pose analyzing apparatus.

FIG. 4 is a flowchart illustrating an example flow of processes performed by the pose analyzing apparatus.

FIG. 5 illustrates the classification of persons in which the type of pose is taken into consideration.

FIG. 6 illustrates an example of the output image.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### <Overview>

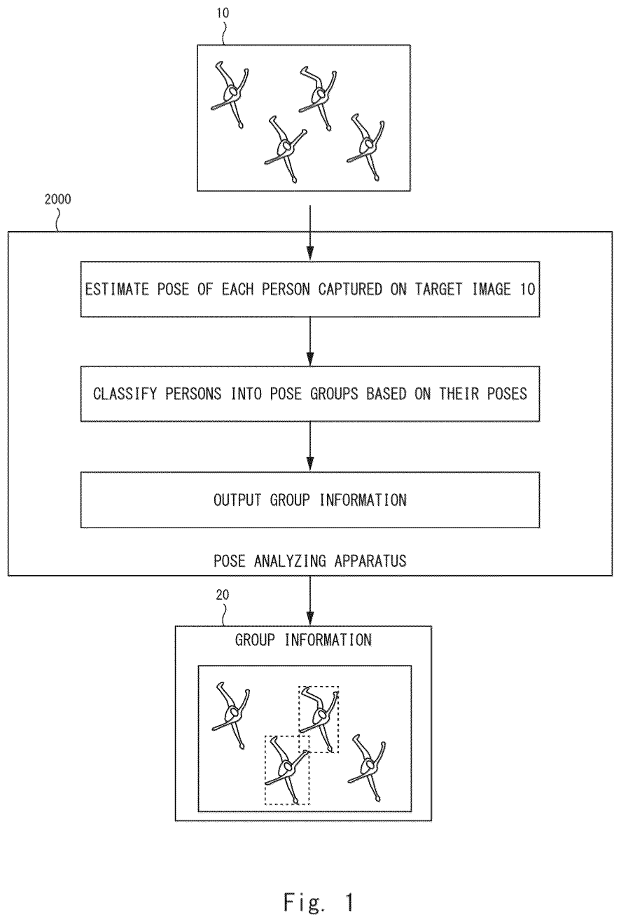

FIG. 1 illustrates an overview of a pose analyzing apparatus 2000 of an example embodiment. It is noted that the overview illustrated by FIG. 1 shows an example of operations of the pose analyzing apparatus 2000 to make it easy to understand the pose analyzing apparatus 2000, and does not limit or narrow the scope of possible operations of the pose analyzing apparatus 2000.

The pose analyzing apparatus 2000 is configured to classify persons captured on a target image 10 into groups according to poses of the persons, and to output information, called “group information 20”, that is related to a result of the classification. The target image 10 is an image data, e.g., an RGB image or a grayscale image, that includes two or more persons in a visible manner.

The persons captured on the target image 10 does arbitrary thing. For example, the persons give a performance, such as figure skating or dance. In another example, the persons perform exercises, such as yoga. In another example, the persons play music instrument, such as guitar or piano. In another example, the persons attend a class in school. In another example, the persons do a task of work, such as operations of assembling components in a factory, or patrols in a building.

To perform the classification of the persons captured on the target image 10, the pose analyzing apparatus 2000 may operate as follows. The pose analyzing apparatus 2000 acquires the target image 10, and estimates a pose for each person captured on the target image 10. Next, the pose analyzing apparatus 2000 classifies the persons into groups, called “pose groups”, based on the estimated poses of the persons. Then, the pose analyzing apparatus 2000 outputs the group information 20 that includes information about one or more pose groups.

It is noted that the pose analyzing apparatus 2000 may handle two or more target images 10 that are generated in parallel and include different persons from each other. In this case, two or more cameras are installed to capture different areas (e.g., different areas in a lesson room in which the persons are taking a lesson of a performance) from each other, and each of the cameras is configured to generate the target image 10. The pose analyzing apparatus 2000 may analyze each of those target images 10 to detect one or more persons therefrom, and classify the detected persons into the pose groups based on their poses.

For the sake of brevity, unless otherwise stated, it is assumed that the pose analyzing apparatus 2000 handles a single target image 10. Unless otherwise stated, the pose analyzing apparatus 2000 that handles two or more target images 10 may operate in the same manner as the pose analyzing apparatus 2000 that handles a single target image 10.

### Example of Advantageous Effect

According to the pose analyzing apparatus 2000 of the example embodiment, the poses of the persons captured on the target image 10 are estimated, and the persons are classified into pose groups based on their poses. Thus, a novel technique of analyzing poses of persons using an image on which two or more persons are captured is provided.

In addition, the pose analyzing apparatus 2000 outputs the group information 20 that indicates information about at least one pose group. Information about the pose group is effective and useful in various ways. Briefly, a viewer of the group information 20 can distinguish the persons belonging to the pose group from the other persons, thereby finding a group of persons whose poses share some characteristics with each other.

For example, as mentioned later in detail, the pose analyzing apparatus 2000 may classify the persons based on the quality of their poses (e.g., degree of similarity to an ideal pose), and output the group information 20 that indicates the pose group with the lowest quality of pose. With this group information 20, the viewer of the group information 20 can be aware of the persons whose quality of performance is lower than that of the other ones. Suppose that the viewer of the group information 20 is a trainer of a performance, and the persons captured on the target image 10 are her or his trainees. In this case, the pose group with the lowest quality of performance can be handled by the trainer as a group of the persons to whom the trainer should pay careful attention and give detailed feedbacks.

Other usefulness or effectiveness of the group information 20 will be described later.

Hereinafter, more detailed explanation of the pose analyzing apparatus 2000 will be described.

### <Example of Functional Configuration>

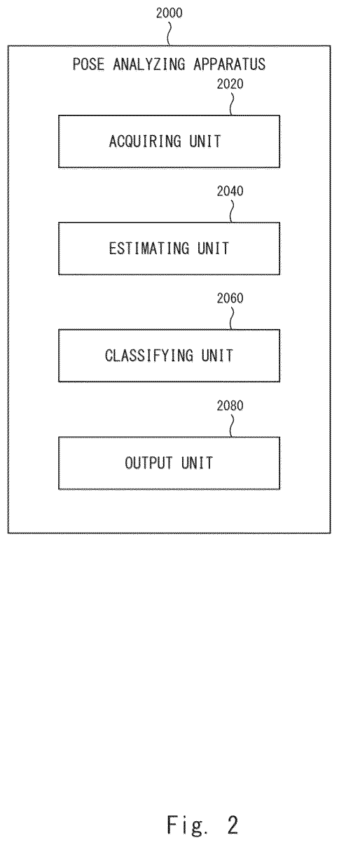

FIG. 2 is a block diagram illustrating an example of the functional configuration of the pose analyzing apparatus 2000 of the example embodiment. The pose analyzing apparatus 2000 includes an acquiring unit 2020, an estimating unit 2040, a classifying unit 2060, and an output unit 2080. The acquiring unit 2020 acquires the target image 10. The estimating unit 2040 estimates the pose of each person captured on the target image 10. The classifying unit 2060 classifies the persons into the pose groups based on the estimated poses of the persons. The output unit 2080 outputs the group information 20.

### <Example of Hardware Configuration>

The pose analyzing apparatus 2000 may be realized by one or more computers. Each of the one or more computers may be a special-purpose computer manufactured for implementing the pose analyzing apparatus 2000, or may be a general-purpose computer like a personal computer (PC), a server machine, or a mobile device.

The pose analyzing apparatus 2000 may be realized by installing an application in the computer. The application is implemented with a program that causes the computer to function as the pose analyzing apparatus 2000. In other words, the program is an implementation of the functional units of the pose analyzing apparatus 2000 that are exemplified by FIG. 2.

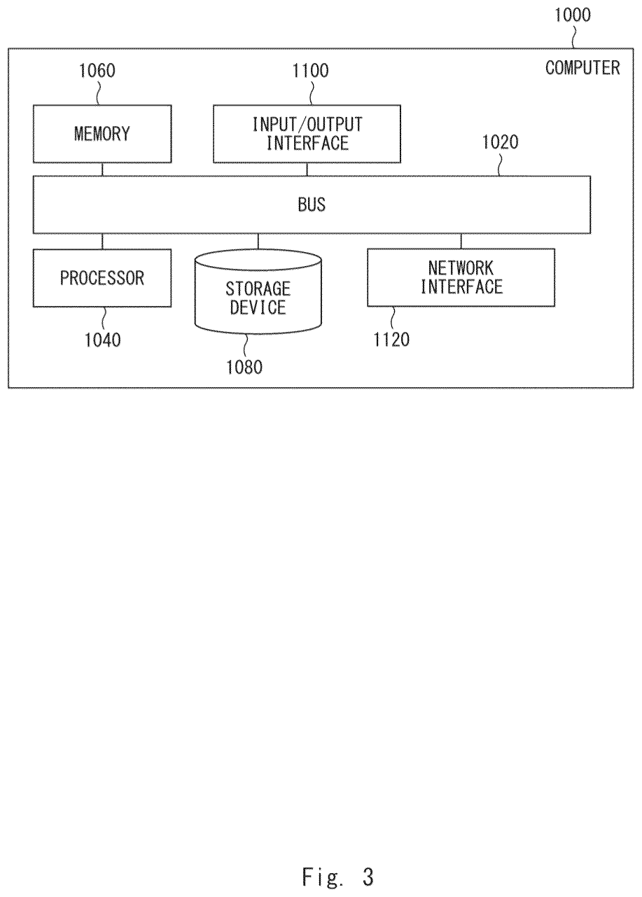

FIG. 3 is a block diagram illustrating an example of the hardware configuration of a computer 1000 realizing the pose analyzing apparatus 2000 of the example embodiment. In FIG. 3, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The hardware configuration of the computer 1000 is not restricted to that shown in FIG. 3. For example, as mentioned-above, the pose analyzing apparatus 2000 may be realized as a combination of multiple computers. In this case, those computers may be connected with each other through the network.

### <Flow of Process>

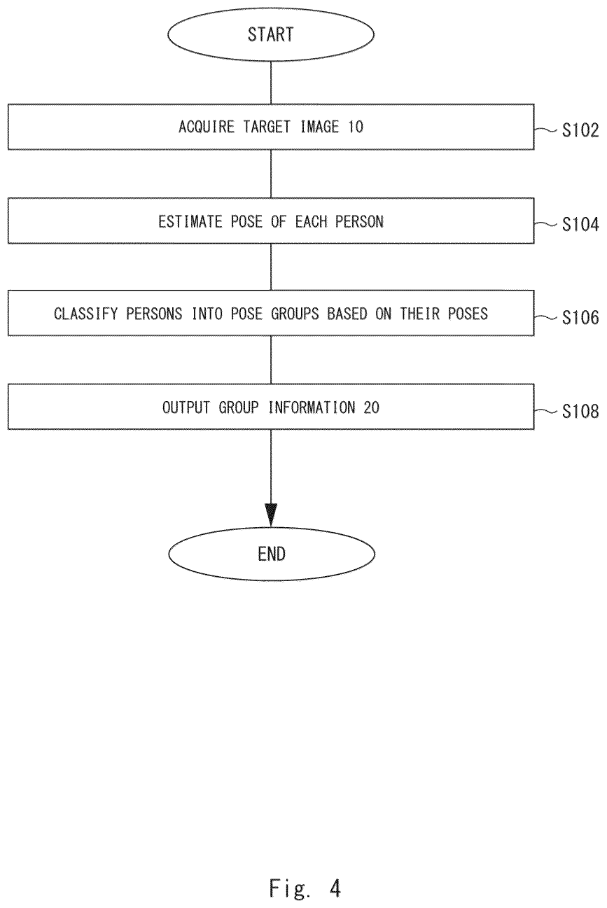

FIG. 4 is a flowchart illustrating an example flow of processes performed by the pose analyzing apparatus 2000 of the example embodiment. The acquiring unit 2020 acquires the target image 10 (S102). The estimating unit 2040 estimates the pose for each of the persons captured on the target image 10 (S104). The classifying unit 2060 classifies the persons into the pose groups based on their poses (S106). The output unit 2080 outputs the group information 20 (S108).

### <Acquisition of Target Image 10: S102>

The acquiring unit 2020 acquires the target image 10 (S102). As mentioned above, the target image 10 includes one or more persons. The person captured on the target image 10 does arbitrary thing. For example, the person gives a performance, such as figure skating or dance. In another example, the person performs exercises, such as yoga. In another example, the person plays music instrument, such as guitar or piano. In another example, the person attends a class in school. In another example, the person does a task of work, such as assembling components in a factory, or patrols in a building.

In some embodiments, the target image 10 is a video frame, which is one of time-series images that constitute a video data, called “target video”. In this case, the acquiring unit 2020 may acquire one or more video frames constituting the target video, and use the acquired video frames as the target images 10. It is noted that there is no need to use all video frames of the target video as the target images 10. For example, the acquiring unit 2020 acquires every predefined number of video frames, such as every 10 video frames, from the target video as the target images 10.

In another example, the acquiring unit 2020 may divide the target video into two or more sections, and acquire one or more video frames from each section as the target images 10. The target video may be divided into sections based on the length of time. Specifically, the target video may be divided into sections each of which has a predefined length of time. In another example, the acquiring unit 2020 recognize two or more scenes captured on the target video, and divide the target video into sections each of which represents one of the recognized scenes. Suppose that a performance of figure skating is captured on the target video. In this case, the target video may include scenes of a jump, a spin, steps, etc. Thus, the acquiring unit 2020 divides the target video into sections of the jump, spin, steps, etc. It is noted that there are various techniques to recognize scenes from a video data, and any one of those techniques can be applied to the acquiring unit 2020 to recognize scenes from the target video.

There are various ways to acquire the target image 10. In some embodiments, the target image 10 is stored in advance in a storage device in a manner that the pose analyzing apparatus 2000 can acquire it. In this case, the acquiring unit 2020 may access the storage device to acquire the target image 10. In other embodiments, the target image 10 may be sent by another computer, such as a camera that generates the target image 10. In this case, the acquiring unit 2020 may acquire the target image 10 by receiving it.

In the case where the acquiring unit 2020 acquires the target video, the target video may be acquired in the same manner as the target image 10. In another example, the acquiring unit 2020 may acquire the target video that is generated in real time. Specifically, a video camera that generates the target video may repeatedly perform: capturing a surrounding scene to generate a video frame of the target video; and output the generated video frame to the pose analyzing apparatus 2000. In this case, the acquiring unit 2020 receives the video frames that are sequentially sent by the video camera, and a time-series of the received video frames forms the target video.

### <Estimation of Poses: S104>

The estimating unit 2040 estimates the pose of each person captured on the target image 10 (S104). There are various techniques of pose estimation, and one of those techniques may be applied to the estimating unit 2040. For example, the estimating unit 2040 detects locations of characteristic parts (such as neck, eyes, shoulders, etc.) of human's body as key-points from the target image 10. Then, the estimating unit 2040 divides the key-points into groups, called “key-point groups”, each of which includes the key-points belonging to the same person as each other, thereby estimating the pose of each person based on the key-point group that corresponds to the person.

The pose of the person may be classified into one of predefined types of poses, such as a jump, a spin, or steps of figure skating. In this case, the pose of a particular person is represented by a pair of the key-point group of the person and a label, called “type label”, that indicates a type of pose taken by the person. In order to recognize the type of pose of the person, the estimating unit 2040 may include a classification model that is configured to take a set of the key-points (i.e., the key-point group) of the person and to output the type label that indicates the type of the pose taken by the person. The classification model may be implemented by a machine learning-based model, such as a neural network.

As mentioned later, the classifying unit 2060 may use not a single pose of the person but a time series of poses of the person to classify the persons into pose groups. In this case, the estimating unit 2040 uses a time series of the target images 10 to estimate poses of the persons from each target image 10, thereby obtaining a time series of poses for each person. It is note that a time series of poses can also be called “motion”. Thus, when the time series of poses of the persons are used for the classification of the persons, it can be said that the pose analyzing apparatus 2000 classifies the persons based on motions of the persons.

<Classification of Persons based on Poses: S106>

The classifying unit 2060 classifies the persons into pose groups based on their poses (S106). Hereinafter, example ways of classifying the person based on their poses are described.

### Example 1

In some embodiments, the persons may be classified based on similarity of their poses to a predefined reference pose. The reference pose may be defined by a set of key-points that represent an ideal pose. In this case, the more similar the pose of the person is to the reference pose, the higher the quality of the pose is.

To describe how similar the pose of the person is to the reference pose, the classifying unit 2060 may compute a similarity score for each person. The similarity score of a particular person may be a value that represents a degree of similarity between the pose of the person and the reference pose.

There are various ways to quantify the similarity between two poses, and one of those ways can be applied to the classifying unit 2060 to compute the similarity score. Briefly, the degree of similarity between the pose of the person and the reference pose may be represented by a degree of similarity between a spatial arrangement of the key-points in the key-point group of the person and a spatial arrangement of the key-points of the reference pose.

In some embodiments, the classifying unit 2060 includes a machine learning-based feature extractor, such as a neural network, that is configured to take a key-point group as input and to output features of the pose represented by the key-point group (e.g., features of the spatial arrangement of the key-points in the key-point group). In this case, the classifying unit 2060 inputs the key-point group of the person into the feature extractor to obtain the features of the pose of the person. The classifying unit 2060 also inputs the key-point group of the reference pose into the feature extractor to obtain the features of the reference pose. Then, the classifying unit 2060 computes, as the similarity score, a value representing the similarity between the features of the pose of the person and the features of the reference pose.

As mentioned above, in some embodiments, the classifying unit 2060 may use a time series of poses (motion) of the person to classify the persons into pose groups. In this case, a time series of reference poses, called “reference motion”, is prepared in advance. The reference motion may be represented by a time-series of key-point groups each of which represent a reference pose at a time. The classifying unit 2060 computes, for each person, the similarity score that represents a degree of similarity between the motion of the person and the reference motion.

There are various ways to quantify the similarity between two motions, and one of those ways can be applied to the classifying unit 2060. Briefly, the degree of similarity between the motion of the person and the reference motion may be represented by a degree of similarity between a time series of spatial arrangements of the key-points of the person and a time series of spatial arrangements of the key-points of the reference motion.

In some embodiments, the classifying unit 2060 includes a machine learning-based feature extractor, such as a neural network, that is configured to take a time-series of key-point groups as input and to output features of the motion represented by the key-point groups. In this case, the classifying unit 2060 inputs the key-point groups of the person into the feature extractor to obtain the features of the motion of the person. The classifying unit 2060 also inputs the key-point groups of the reference motion into the feature extractor to obtain the features of the reference motion. Then, the classifying unit 2060 computes, as the similarity score, a value representing the similarity between the features of the motion of the person and the features of the reference motion.

Based on the similarity score of the persons, the persons are classified into the pose groups. For example, the classifying unit 2060 may generate the predefined number of pose groups that are initialized to be empty. Each pose group is associated with a range, called “score range”, of similarity score. The score ranges are defined not to overlap each other.

Suppose that a whole range of the similarity score S is 0<=S<=100, and two pose groups GP1 and GP2 are defined. In this case, the pose groups GP1 and GP2 can be defined as follow: the pose group GP1 has the score range of 0<=S<50; and the pose group GP2 has the score range of 50<=S<=100.

The classifying unit 2060 determines, for each person, one of the score ranges that includes the similarity score of the person, and assign the person to the pose group that corresponds to the determined score range. Suppose that there are two pose groups GP1 and GP2 mentioned above. In addition, there are five persons P1 with the similarity score of 20, P2 with the similarity score of 70, P3 with the similarity score of 60, P4 with the similarity score of 45, and P5 with the similarity score of 10. In this case, the persons P1, P4, and P5 are assigned to the pose group GP1 since their similarity scores are within the score range 0<=S<50 whereas the persons P2 and P3 are assigned to the pose group GP2 since their similarity scores are within the score range 50<S<=100.

If the persons captured on the target image 10 are trainees of a performance, such as dance or figure skating, it can be said that the pose group GP1 is a group of the trainees whose quality of performance is lower than that of the trainees in the pose group GP2. Thus, a trainer of those trainees can realize that she or he should pay more attention to the persons in the pose group GP1 than those in the pose group GP2 in order to give detailed feedbacks to the persons in the pose group GP1.

### Example 2

In some embodiments, the persons may be divided into the pose groups based on similarity among their poses. This means that the persons taking similar poses to each other are assigned to the pose group same as each other, while the persons taking dissimilar poses from each other are assigned to the pose groups different from each other.

To do so, the classifying unit 2060 may perform clustering, such as k-means clustering, on the key-point groups to divide the key-point groups into two or more clusters. Each cluster represents a group of the persons that take similar poses to each other. Thus, each cluster can be handled as the pose group. It is noted that the key-point group can be represented by a multi-dimensional data (e.g., an array of locations of body parts), and there are various ways to perform clustering on a set of multi-dimensional data. Thus, one of those ways can be applied to the classifying unit 2060 to perform clustering on a set of the key-point groups. It is also noted that the number of the clusters (in other words, the number of the pose groups) may be defined in advance or may be determined dynamically as a result of the clustering.

As a result of the classification mentioned above, the pose groups may differ in quality of their poses. Suppose that the persons captured on the target image 10 are trainees and the classifying unit 2060 generates three pose groups as a result of the clustering mentioned above. In this case, those pose groups may include the first pose group with high level of performance, the second pose group with middle level of performance, and the third pose group with low level of performance. Thus, the pose analyzing apparatus 2000 can make it easy for a trainer of the trainees to distinguish performance levels of the trainees and to be aware of the trainees to whom the trainer should pay attention.

From another point of view, as a result of the classification, the pose group may include the persons who make similar mistakes in their poses. This means that the pose group may indicate a group of the trainees to which the instructor can give common advices. Thus, the pose analyzing apparatus 2000 can increase the efficiency of instructor's works.

As mentioned above, in some embodiments, the classifying unit 2060 may use a time series of poses (motion) of the person to classify the persons into pose groups. In this case, the classifying unit 2060 may perform clustering on a set of motions of the persons. The motion of a particular person can be represented by a time series of key-point groups, each of which is a multi-dimensional data (e.g., an array of locations of body parts). There are various ways to perform clustering on a set of multiple time-series of multi-dimensional data, and one of those ways can be applied to the classifying unit 2060 to perform clustering on a set of motions of the persons.

### <<Consideration of Type of Pose>>

In the case where different types of poses are taken in the target image 10, the classifying unit 2060 may classify the pose of the person based on the type of pose. Suppose that trainees take a lesson of a performance in which different types of poses are taken simultaneously. This means that there are groups of trainees that take different poses from each other. In this case, the comparison of the quality of poses should be performed for each type of pose. Thus, it is preferable to generate a set of the pose groups for each type of pose.

In this case, the estimating unit 2040 estimates the pose of each person by generating the key-point group of the person and determining the type label of the person. Then, the classifying unit 2060 divides the persons into groups, called “type groups” based on their type labels (i.e., types of poses). The type group is generated for each type of pose. The type group of a particular type of pose includes the persons whose type label indicates the type of pose corresponding to the type group. For each type group, the classifying unit 2060 classifies the persons into the pose groups in the ways mentioned above.

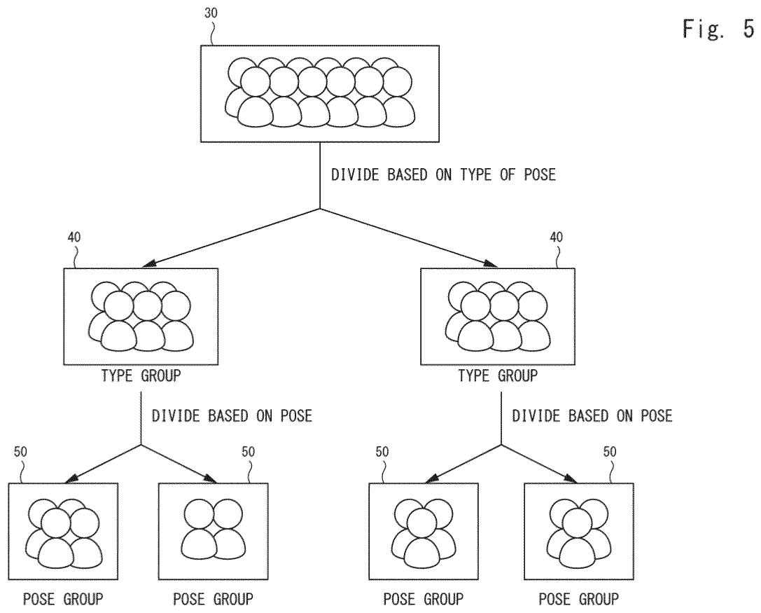

FIG. 5 illustrates the classification of persons in which the type of pose is taken into consideration. First, a set 30 of the persons that are captured on the target image 10 is divided into type groups 40 based on the type of pose of each person. Then, each type group 40 is divided into pose groups 50 based on the poses of the persons in the type group.

When the persons are classified into the pose groups based on the reference pose (i.e., in the case of Example 1), the reference pose is prepared for each type of pose since each type of pose has its own ideal pose. For each type group, the classifying unit 2060 may operate as follows. First, the classifying unit 2060 computes the similarity score of the person that indicates the similarity between the pose of the person and the reference pose corresponding to the type group. Then, the classifying unit 2060 assigns each person in the type group to one of the pose groups based on the similarity score thereof.

Suppose that the target image 10 includes ten persons P1 to P10: P1 to P4 are taking a pose of type T1; and P5 to P10 are taking a pose of type T2. In this case, the classifying unit 2060 assigns the persons P1 to P4 to a type group GT1 that corresponds to the type T1. On the other hand, the classifying unit 2060 assigns the persons P5 to P10 to a type group GT2 that corresponds to the type T2. In this example, two pose groups are prepared for each type group: pose groups GP1 and GP2 are for the type group GT1; and pose groups GP3 and GP4 are for the type group GT2. The classifying unit 2060 assigns each of the persons P1 to P4 to the pose group GP1 or GP2 based on the similarity of their poses to a reference pose RP1 that represents an ideal pose of the type T1. On the other hand, the classifying unit 2060 assigns each of the persons P5 to P10 to the pose group GP3 or GP4 based on the similarity of their poses to a reference pose RP2 that represents an ideal pose of the type T2.

When the persons are classified into the pose groups based on the similarity among their poses (i.e., in the case of Example 2), the classifying unit 2060 may perform clustering on each type group, thereby each type group is divided into two or more pose groups. Suppose that the target image 10 includes the persons P1 to P10 mentioned above. In this case, the classifying unit 2060 performs clustering on the type group GT1, thereby dividing the persons P1 to P4 into two or more pose groups. Similarly, the classifying unit 2060 performs clustering on the type group GT2, thereby dividing the persons P5 and P10 into two or more pose groups.

It is noted that when the classification of persons is performed based on their motions, the type label of the person is determined to represent the type of the motion of the person, and the type group is generated to include the persons whose motion is of the type corresponding to the type group. In addition, when the persons are classified into the pose groups based on the reference motion (i.e., in the case of Example 1), the reference motion is prepared for each type of motion since each type of motion has its own ideal motion.

<Output of Group information 20: S108>

The output unit 2080 outputs the group information 20 (S108). The group information 20 includes one or more pieces of information related to one or more pose groups. In some embodiments, the output unit 2080 modifies the target image 10 so that a viewer of the modified target image 10 can notice one or more pose groups, and the modified target image 10 (hereinafter, called “output image”) is included in the group information 20. For example, the output image includes common marks, such as bounding boxes with the same color as each other, on or around the persons that belong to the same pose group as each other.

The marks may be added for a single pose group or for two or more pose groups. In the former case, the marks are used to highlight the pose group of the persons to which a viewer, e.g., a trainer, should pay attention. For example, the pose group with the lowest level of performance (e.g., with the smallest similarity score) may be highlighted.

In the case where the marks are added for two or more pose groups, the different types of marks may be used for each pose group. For example, the color, shape, or line of the mark is defined for each pose group.

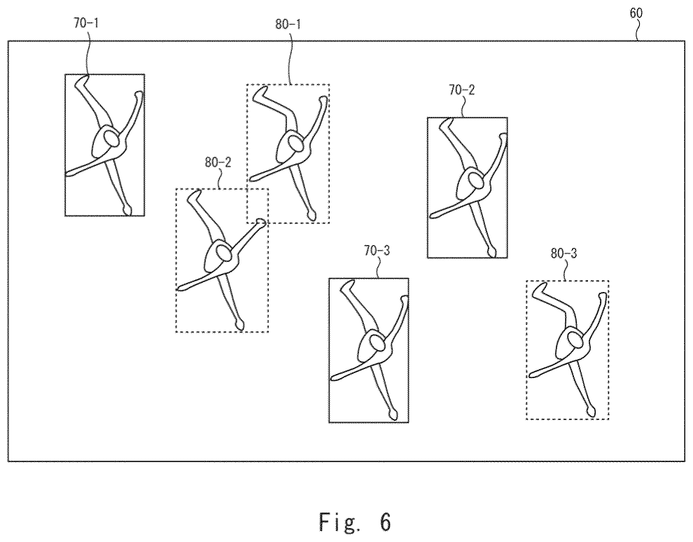

FIG. 6 illustrates an example of the output image. In an example case shown by FIG. 6, it is assumed that two pose groups GP1 and GP2 are generated. The output image 60 includes marks 70-1 to 70-3 to show the persons included in the pose group GP1, and marks 80-1 to 80-3 to show the persons included in the pose group GP2. The marks 70 are bounding boxes with solid lines whereas the marks 80 are bounding boxes with doted lines. Since their types of line are different from each other, a viewer of the output image 60 can easily and naturally notice that the persons captured by a camera are divided into two groups and which person belongs to which group.

The output image 60 may also include information that indicates one or more features of each pose group. By doing so, the viewers of the output image 60 can easily understand the features of each pose group.

For example, the features of the pose group may include a start, an end, or both of the score range of the pose group. In another example, the features of the pose group may include a rank of the pose group. In this case, the pose groups may be ranked by the score range. Suppose that three pose groups are generated based on the similarity score of each person. In this case, these pose groups may be ranked as high quality, middle quality, and low quality, respectively. Thus, the output image 60 may include information that indicates which mark represents which rank.

Additionally or alternatively, the output image 60 may include information that indicates one or more features of each person, e.g., similarity score. When the marks are not added to all pose groups, the output image 60 may show the features only for the persons for which the marks are added.

Additionally or alternatively, the group information 20 may include statistics regarding the pose groups. An example of the statistics regarding the pose group is a percentage of the persons in each pose group. Suppose that there are two pose groups GP1 and GP2: GP1 is a pose group with the higher quality of performance and includes 6 persons; and GP2 is a pose group with the lower quality of performance and includes 14 persons. In this case, the percentage of the pose groups GP1 and GP2 are 30% and 70%, respectively. This information lets the viewer of the group information 20 easily realize how large the percentage of a particular pose group is: e.g., how large the percentage of the persons whose quality of performance is low.

When the pose groups are generated by clustering (i.e., Example 2 of the classification), the percentage of a particular pose group may represent the percentage of the persons who take similar poses to each other. This information may useful when, for example, the persons captured on the target image 10 is giving a performance in which all performers are required to take the same pose as each other, such as line dance or artistic swimming. In this case, the percentage of the pose group in which the persons take a correct pose may be used as an index of the quality of an overall performance. Thus, the viewer of the group information can easily realize the quality of an overall performance.

There are various ways to output the group information 20. In some implementations, the group information 20 may be put into a storage device, displayed on a display device, or sent to another computer such as a PC or smart phone of the user of the pose analyzing apparatus 2000.

In some embodiments, the pose analyzing apparatus 2000 acquires the target images 10 constituting the target video and output the group information 20 in real time. In this case, the viewer can easily notice the pose groups in real time. Suppose that one or more cameras are installed in a lesson room where multiple trainees take a lesson of a performance, generate the target images 10 constituting the target video, and send them to the pose analyzing apparatus 2000. In addition, the pose analyzing apparatus 2000 receives the target image 10, classifies the persons on the target images 10 into pose groups, and output a sequence of the output images, called “output video”, to a display device in real time. In this case, a trainer of the trainees can easily realize pose groups in real time by watching the output video displayed on the display device. This enables the trainer to, for example, realize the performance level of each trainee. Thus, the trainer can easily give appropriate feedbacks to the trainees. In particular, as mentioned above, the trainer may be able to be aware of a group of the trainees whose quality of performance is lower than the rest of them, and can therefore pay attention to those trainees in order to give them detailed feedbacks.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

### REFERENCE SIGNS LIST

10 target image
20 group information
30 set
40 type group
50 pose group
60 output image
70 mark
80 mark
1000 computer
1020 bus
1040 processor
1060 memory
1080 storage device
1100 input/output interface
1120 network interface
2000 pose analyzing apparatus
2020 acquiring unit
2040 estimating unit
2060 classifying unit
2080 output unit

What is claimed is:

1. A pose analyzing apparatus comprising:
at least one memory that is configured to store instructions; and
at least one processor that is configured to execute the instructions to:
acquire a target image on which two or more persons are captured;
estimate a pose for each one of the persons;
classify the persons into two or more pose groups based on the poses of the persons; and
output group information indicating at least one of the pose groups.

2. The pose analyzing apparatus according to claim 1,
wherein the classification of the persons includes:
for each one of the persons, computing a similarity score that represents a degree of similarity between the pose of the person and a reference pose; and
assigning each person to the pose group corresponding to the similarity score of the person, the pose groups being associated with different ranges of the similarity score from each other.

3. The pose analyzing apparatus according to claim 1,
wherein the classification of the persons includes performing clustering on the persons based on their poses to divide the persons into two or more clusters, thereby obtaining clusters as the pose groups.

4. The pose analyzing apparatus according to claim 1,
wherein the classification of the persons includes:
classifying the persons into two or more type groups based on types of the poses of the person, the type groups being associated with different types of poses from each other; and
for each one of the type groups, classifying the persons in the type group into the pose groups.

5. The pose analyzing apparatus according to claim 1,
wherein the group information includes an output image that is generated by modifying the target image to show common marks for the persons that belong to a same pose group as each other.

6. A pose analyzing method performed by a computer, comprising:
acquiring a target image on which two or more persons are captured;
estimating a pose for each one of the persons;
classifying the persons into two or more pose groups based on the poses of the persons; and
outputting group information indicating at least one of the pose groups.

7. The pose analyzing method according to claim 6,
wherein the classification of the persons includes:
for each one of the persons, computing a similarity score that represents a degree of similarity between the pose of the person and a reference pose; and
assigning each person to the pose group corresponding to the similarity score of the person, the pose groups being associated with different ranges of the similarity score from each other.

8. The pose analyzing method according to claim 6,
wherein the classification of the persons includes performing clustering on the persons based on their poses to divide the persons into two or more clusters, thereby obtaining clusters as the pose groups.

9. The pose analyzing method according to claim 6,
wherein the classification of the persons includes:
classifying the persons into two or more type groups based on types of the poses of the person, the type groups being associated with different types of poses from each other; and
for each one of the type groups, classifying the persons in the type group into the pose groups.

10. The pose analyzing method according to claim 6,
wherein the group information includes an output image that is generated by modifying the target image to show common marks for the persons that belong to a same pose group as each other.

11. A non-transitory computer-readable storage medium storing a program that causes a computer to execute:
acquiring a target image on which two or more persons are captured;
estimating a pose for each one of the persons;
classifying the persons into two or more pose groups based on the poses of the persons; and
outputting group information indicating at least one of the pose groups.

12. The storage medium according to claim 11,
wherein the classification of the persons includes:
for each one of the persons, computing a similarity score that represents a degree of similarity between the pose of the person and a reference pose; and
assigning each person to the pose group corresponding to the similarity score of the person, the pose groups being associated with different ranges of the similarity score from each other.

13. The storage medium according to claim 11,
wherein the classification of the persons includes performing clustering on the persons based on their poses to divide the persons into two or more clusters, thereby obtaining clusters as the pose groups.

14. The storage medium according to claim 11,
wherein the classification of the persons includes:
classifying the persons into two or more type groups based on types of the poses of the person, the type groups being associated with different types of poses from each other; and
for each one of the type groups, classifying the persons in the type group into the pose groups.

15. The storage medium according to claim 11,
wherein the group information includes an output image that is generated by modifying the target image to show common marks for the persons that belong to a same pose group as each other.
